(19) United States
(12) Patent Application Publication
(10) Pub. No.: US 2002/0071572 A1
(43) Pub. Date: Jun. 13, 2002

(54) Process for the configuration of a public address system and a configurable public address system

(76) Inventor: Sven Moertel, Backnang (DE)

Correspondence Address: CHRISTIE, PARKER & HALE, LLP, 350 WEST COLORADO BOULEVARD, SUITE 500, PASADENA, CA, 91105, US

(21) Appl. No.: 09/999,748

(22) Filed: Oct. 23, 2001

(30) Foreign Application Priority Data
Oct. 25, 2000 (DE) 100 52 896.1

(51) Int. Cl. H04R 27/00; H04R 29/00

(52) U.S. Cl. 381/82; 381/56; 381/79

(57) ABSTRACT

A process for the configuration of a public address system with at least one speaker box (8) and one amplifier (1) including a DSP (2.2) in the audio signal path supplying the speaker box (8) with an audio signal uses data that are transmitted by the speaker box (8) transmitted to the amplifier (1). Using these data, signal processing adapted to sound technology and/or electrical characteristics or surrounding conditions of the speaker box is adapted in the DSP (2.2), possibly in other functional elements of the amplifier (1). The data concern desired signal processing in the amplifier and are structured in a data format not specific to the DSP. They are converted in the amplifier (1) into DSP-specific parameter data. For the data conversion, interpretation data contained in the amplifier (1), which data relate to information concerning the DSP (2.2), possibly to additional functional elements in the amplifier (1), are used.

The invention concerns a process for the configuration of a public address system with at least one speaker box and one amplifier including a DSP in the audio signal path supplying the speaker box with an audio signal. The invention further concerns a configurable public address system as well as a speaker box and an amplifier which can be used in such a configurable public address system.

Public address systems are often set up solely for the purpose of the execution of individual events, for example, to provide sound to a hall or a fairground. The systems are mobile, and almost always multiple speaker boxes and often multiple amplifiers as well are available. For this, it is necessary to take into account the fact that both the amplifiers and the speaker boxes are frequently not identical, but rather are of different types, which means that the individual amplifiers have different electrical characteristics and the speaker boxes have different sound technology and/or electronic technology parameters. Besides that, the structure of the overall public address system must satisfy different requirements, depending on its type and the acoustic conditions of the event. For example, it is conceivable that the same amplifier will operate with speaker boxes of type A at a first event and at a subsequent event speaker boxes of type B will be connected to this amplifier. At a third event, speakers of both type A and of type B will be operated together on the aforementioned amplifier.

The ever-changing structure of the public address system results in the fact that optimum acoustic results are not always achieved.

In this connection, in DE 197 26 176 C1, adaptation of the amplifier to a speaker box connected thereto has already been proposed. There, data are communicated to the amplifier via a communication connection from the speaker box using sound technology and/or electrical parameters of the speaker box. The data communicated are, for example, a type name of the speaker box or other data that enable error-free identification of the speaker box in the amplifier. Operational data of the speaker box, electrical parameters of the speaker box, sound technology parameters of the speaker box, or additional information with regard to the spatial acoustics can also be communicated to the amplifier. Using the data received, the appropriate amplification settings are undertaken in the amplifier.

Disadvantageously, with this process, for each speaker type, special adjustment data records specific to this associated speaker must be maintained in the amplifier. These adjustment data are then used for device-specific adjustment of the DSP (digital signal processor) and possibly other components in the amplifier. With the introduction on the market of new speakers, these device-specific adjustment data in the amplifier must be repeatedly updated to the latest technology, a situation associated with high expense.

Another possibility for achieving adaptation of the amplifier to the speaker would consist, in principle, of storing the necessary amplifier-specific adjustment data records directly in the speaker and transmitting them to the amplifier via the existing communication connection at the time of each operation. However, with this procedure, the problem arises that the adjustment data stored in the speaker must be specifically tailored to the respective hardware in the amplifier (microprocessor, DSP, memory, etc.) and, consequently, are no longer usable after a generational change of amplifiers.

The object of the invention is to report a process for the configuration of a public address system that enables optimization of the system with any combinations of amplifier and speaker box. Moreover, a corresponding public address system and speaker box, as well as a correspondingly configurable amplifier are provided.

The object is accomplished according to the invention by the characteristics of claims 1, 16, 17, and 18.

According to the invention, data which relate to specific, desired signal processing in the amplifier are stored in the speaker box. By means of these data, the speaker box defines the signal processing in the amplifier which results in the best possible acoustic result. The data may thus be considered a “prescription for optimized amplifier operation”. The data are present, however, in a data format specific neither to amplifier hardware/software nor to a speaker. This means that the data are stored in the speaker box in a form predefined by universal rules (which are independent of the actual amplifier used and the actual speaker box used) and are transmitted in that form. The expression data format refers to the totality of these rules or conventions.

The data are transmitted from the speaker box to the amplifier and interpreted there. Interpretation data contained in the amplifier are used for the data interpretation. The interpretation data include the necessary information concerning the digital signal processor section used, in particular DSP, and, consequently, enable the calculation or generation of the specific parameter data essential for the adjustment of the digital signal processing section. Among other things, the interpretation data may indicate which signal processing steps can be performed by the DSP implemented in the amplifier in the specific case, for what signal processing steps additional components are present in the amplifier, and, on the other hand, which signal processing steps are not supported by the actual amplifier hardware/software. The interpretation data thus presuppose accurate knowledge concerning the DSP used in the amplifier and include the hardware-specific data with which the data transmitted from the speaker box can be converted into DSP-specific adjustment or parameter data. In addition to these interpretation data, the knowledge of the data format (i.e., the conventions according to which the data transmitted from the speaker box are structured) is essential for the data conversion. Since this involves a universal data format (i.e., not specific to amplifier hardware/software and speaker box), introduction on the market of new speaker boxes for new amplifier technologies represents no obstacle for data interpretation in future systems.

And finally, with the invention, a new translation or interpretation level is introduced between the data originating from the speaker box and the amplifier-hardware/software, which makes it possible to operate and to mix speaker boxes and amplifiers in a self-configuring public address system across types and generations.

In addition to the essential universality, the presentation of the data in the speaker box supports a minimum computation outlay for the interpretation of the data and the shortest possible data transmission times. This requires the optimization of the form of presentation of the data (i.e., the data format), particularly with regard to avoidance of redundancy in the data records.

Preferably, the data stored in the speaker box are subdivided into multiple data records. In each case, data records contain data with a common connection as to content.

Preferably, at least some of the data records are, in each case, associated with a known functional element in amplifier technology, whereby the respective functional element is uniquely identifiable by means of a functional element identification data field in the data records. The functional element identification data field facilitates the interpretation of the data received. The term functional element is understood in the broad sense and can refer both to a hardware component (either hybrid or integrated into the DSP) and to a software module in the signal processing section of the amplifier. For example, a first data record can be associated with a filter sequence, a second data record with a peak limiter to avoid a short-term speaker overload, a third data record with a cone excursion limiter to restrict the deflection of the cone, a fourth data record with a continuous output limiter (sometimes also referred to as a thermal limiter) to limit the continuous output power of the amplifier, a fifth data record with a relative time delay of the audio signal with reference to other outputs of the amplifier, and a sixth data record with the overall amplification and the phase of the audio signal output by the amplifier (the numbering implies no special sequence of the data records in the data format).

The more data records present, the more “adaptive” and complex the signal processing in the amplifier can be. It makes no difference which of the signal processing steps are usually performed in a DSP and which of the signal processing steps are usually performed in DSP-external components or functional groups in the amplifier. The reason for this is that the actual “task distribution” with regard to the individual signal processing steps is independent of the nature of the amplifier hardware/software and, consequently, does not have to be taken into account until the interpretation of the data to be performed in the amplifier.

The first data record (which is associated with a filter sequence) may also have a filter identification data field, used for the identification of different filter types. This means that a data record can contain information with regard to multiple different filter types; moreover, this facilitates the expandability and simple interpretability of the data record.

Another preferred format convention consists in that a data record has a data record identification data field. This data field can, for example, contain a serial number and enables, in a simple manner, differentiating between data records associated with identical functional elements (i.e., which have identical functional element identification data fields). The result is that multiple versions of a data record can be stored for one and the same component. Providing a data record identification data field in the data record takes into account the fact that, for a speaker box, there is, under certain circumstances, not just one valid adjustment of the amplifier, in particular of the DSP. Because, for various modes of operation and layout capabilities, etc., of the speaker box, there are different optimized parameter data for the amplifier. Consequently, in the manner indicated, the data format offers the capability of specifying different versions of data records which (depending on the data interpretation) result in different adjustments of the amplifier and/or DSP. The adjustment variants can then be selected on the amplifier or on the respective amplifier channel.

Also essential for the data conversion are the interpretation data contained in the amplifier. These data exclusively concern information with regard to the hardware and possibly software (firmware) used in the amplifier and are, consequently, also already available before the downloading of data from the speaker box to the amplifier. The interpretation data are independent of the respective speaker box actually connected, i.e., it is unnecessary to update the interpretation data upon market introduction of new speakers. An update of the interpretation data may, however, become necessary in the event of a retrofitting of the amplifier (e.g., replacing the DSP or reprogramming the DSP). Consequently, it may be advantageous to keep the interpretation data in a programmable memory which can be written to via an interface.

In contrast to the data transmitted by the speaker box, the interpretation data may be kept in a freely selectable (i.e., device-specific) data format in the amplifier.

Preferably, the interpretation data include data which are associated with the channel structure of the amplifier, for instance, information concerning the number and organization of the individual channels; data about the sampling rate used in the DSP; an indication of the amplification factor of a power amplifier stage of the amplifier; an indication of the short-term output voltage, e.g., as a sine mean, of a power amplifier stage of the amplifier; and data about the internal delays of an analog-digital converter or a digital-analog converter in the audio signal path of the amplifier upstream and downstream of the DSP. All these amplifier specifications, which can be supplemented by additional data even with regard to software (firmware) operating in the amplifier, enable the evaluation of the data received by the speaker and the calculation of the amplifier-hardware/software-specific adjustment parameters to implement the signal processing desired from the speaker in the digital signal processing section of the amplifier, in particular in the DSP.

An advantageous provision of the process according to the invention consists in that before the conversion of the data received into parameter data for the digital signal processing section, a check is run to determine whether the signal processing requested is, in fact, available. A simple form of such a check consists, for example, in checking whether an adequate number of amplifier channels is present in the amplifier and whether adequate output power is available from the amplifier. In addition, it is also possible, for example, to check whether the digital signal processing section, in particular DSP or the DSP software (firmware), supports signal processing steps requested. If the check yields the result that a signal processing requested cannot be performed by the digital signal processing section, this can be communicated to the user by output of a warning.

Moreover, a warning can be advantageously issued if, in the conversion of the data, the occurrence of an error is detected.

In addition, the amplifier operates without corresponding data from the speaker box in a preset standard operating mode. If a connected speaker box communicates data which relate to only part of the signal processing functions available in the digital signal processing section, in particular DSP, provision is advantageously made that the remaining signal processing functions are defined according to the predefined settings.

With regard to the speaker box according to the invention, a significant point consists in that this includes a data memory, in which the data concerning the desired signal processing in an amplifier are stored in a predefined data format independent of the type of the speaker. These can then be evaluated and used in the manner already described by an amplifier that has the above-described data interpretation functionality.

A significant point of the amplifier according to the invention consists in that it includes an interpretation unit which calculates the parameter data from the data obtained from the speaker box using interpretation data that are suitable and essential for the configuration of the digital signal processing section, in particular DSP.

The invention is explained in detail in the following using examples and with reference to the drawings; they depict:

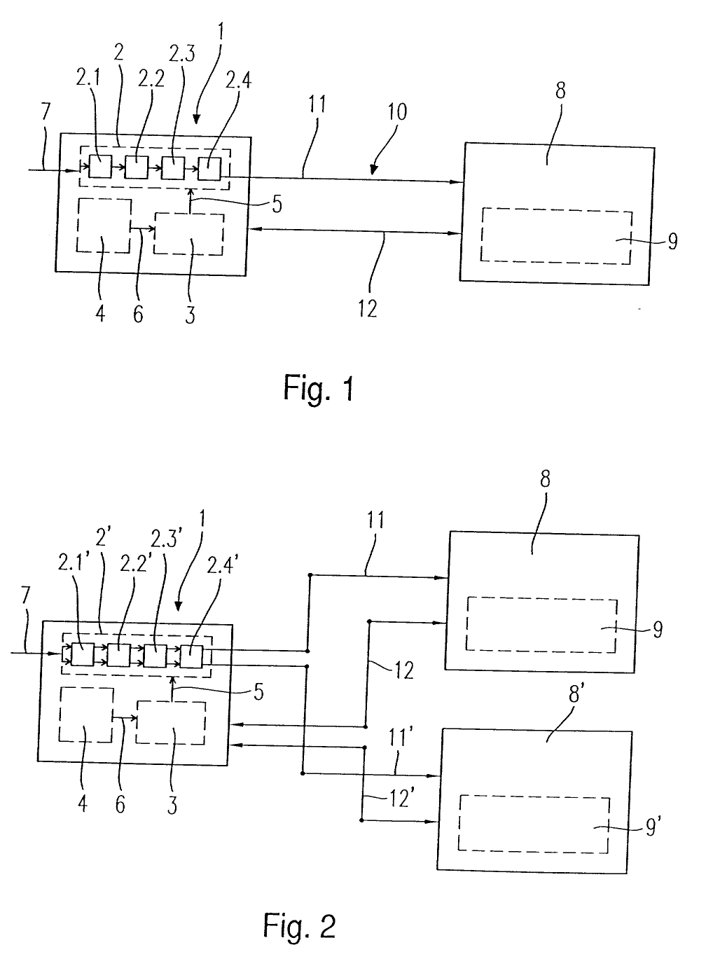

FIG. 1 a block diagram of a public address system according to the invention;

FIG. 2 a block diagram of another public address system according to the invention;

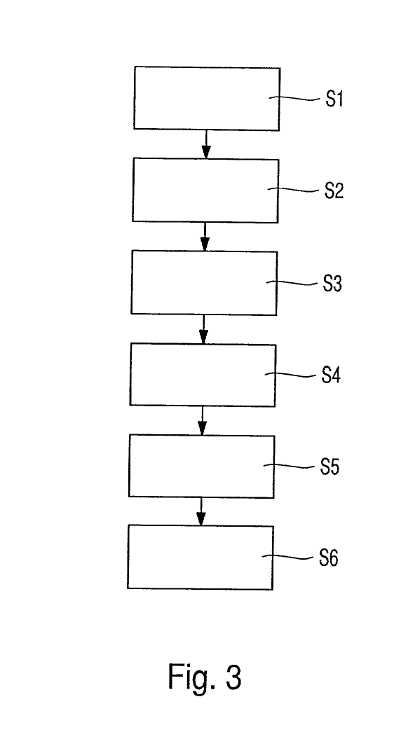

FIG. 3 a flowchart to illustrate the process according to the invention;

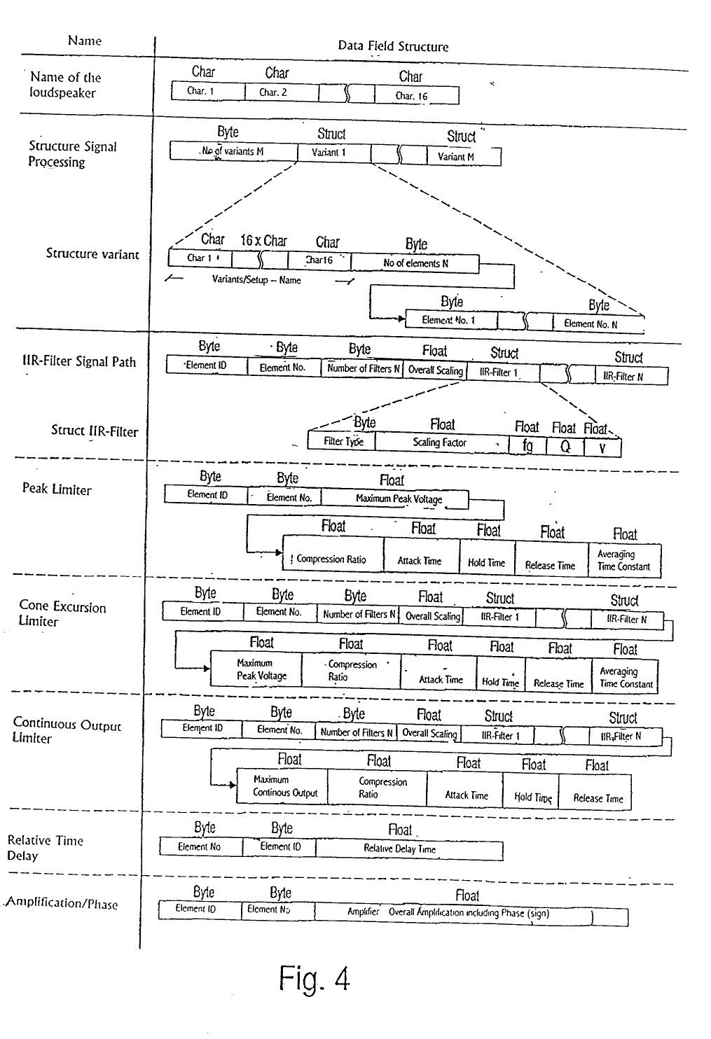

FIG. 4 a graphic to illustrate a data format of the data contained in the speaker; and

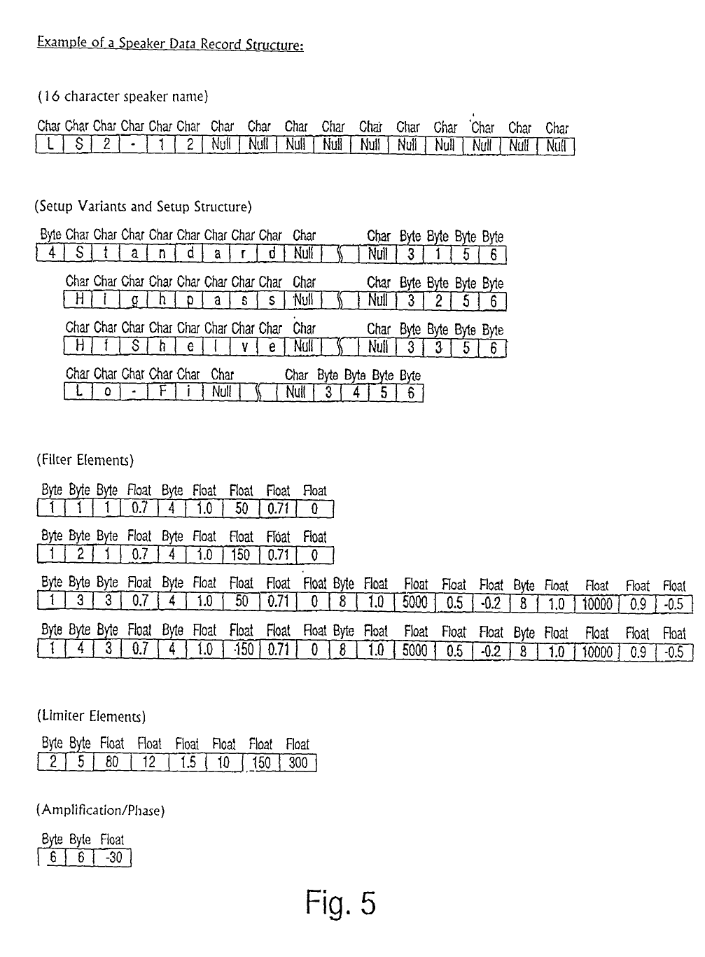

FIG. 5 an example of a file to describe signal processing in the amplifier based on the data format depicted in FIG. 4.

FIG. 1 schematically depicts an amplifier 1 designed as a power amplifier. The amplifier 1 has an audio signal processing circuit referenced in its totality as 2. The audio signal processing circuit 2 includes a DSP 2.2, usually an analog-digital converter 2.1 connected upstream from the DSP 2.2, as well as a digital-analog converter 2.3 connected downstream from the DSP, and a power amplifier stage 2.4. The analog-digital and digital-analog converters 2.1, 2.3 are optional, since a digital input signal may also be fed to the amplifier 1; and, moreover, amplification may already occur in the digital signal area. Also, additional amplifier components may be included in the audio signal processing circuit 2. The amplifier 1 also includes a configuration circuit 3. A data memory 4 is associated with the configuration circuit 3. The configuration circuit 3 is in data connection with the audio signal processing circuit 2 via data transmission means (e.g., data bus) 5 and is capable of reading out data from the data memory 4 via a data transmission means 6. The input signal for the amplifier 1 is referenced as 7.

A storage medium 9 is associated with a speaker box 8. The speaker box 8 is connected via a cable connection 10 with the amplifier 1, whereby the cable connection 10 consists of a speaker cable 11 and a data transmission line 12. It is discernible from the direction of the arrow that audio signals corresponding to the operation of the speaker 8 are transmitted from the amplifier 1 to the speaker box 8. The data transmission line 12 is provided with double-headed arrows, indicating that a bidirectional data exchange is possible between the configuration circuit 3 and the storage medium 9.

Another possibility consists in also using the speaker cable 11 for the data transmission. In this case, the separate data transmission line 12 is omitted.

FIG. 2 depicts another example of a public address system in which the same or functionally similar parts are referenced with the same reference characters as in FIG. 1. In contrast with FIG. 1, here, two speaker boxes 8 and 8′ with associated storage media 9 and 9′, respectively, are connected with the amplifier 1. The signal and data transmission between the amplifier 1 and the speaker boxes 8 and 8′ occurs via the speaker cables 11, 11′ and 12, 12′, respectively. The audio signal processing circuit 2′ is implemented with two channels in the example depicted (analog-digital converter 2.1′, DSP 2.2′, digital-analog converter 2.3′, power amplifier stage 2.4′), whereby individual signal processing is possible in each channel. In other words, the DSP 2.2′ can receive different parameter values for each channel and use them as adjustment values, and, furthermore, the audio signal can be amplified differently in each channel. The audio signal processing circuit 2′ can also have significantly more than two channels.

The mode of operation of the public address system depicted in FIG. 1 and 2 is explained with reference to FIG. 3.

First, in step S1, the amplifier 1 is turned on. By manual input or direct checking of the connection status of its channels, the amplifier 1 finds out or calculates, in step S2, whether and to which output connections speaker boxes 8, 8′ are connected.

In step S3, the data stored in the storage media 9, 9′ of the speakers 8, 8′ is transmitted into the configuration circuit 3 of the amplifier 1. Usually, a communication request is sent for this purpose by the configuration circuit 3 to the connected speaker box 8, 8′, whereupon the data stored in the storage media 9, 9′ are transferred into storage area (not shown) associated with the configuration circuit 1 [sic]. The data query can be simultaneous or can be separate for each speaker box 8, 8′.

When the configuration circuit 3 has received the desired data, complete information concerning the signal processing functions desired by the speaker boxes 8, 8′ is present in the amplifier 1.

In a next step S4, these preset data are interpreted. This step is necessary since the data received from the speaker boxes 8, 8′ are prepared in a universal format and, thus, cannot be “copied” directly as adjustment parameters for the DSP 2.2, 2.2′.

The data interpretation, which is now explained in detail with reference to FIG. 4 and 5, is based on additional information about the hardware and/or software structure in the amplifier, which is available to the configuration circuit 3. This additional information is stored in the form of so-called interpretation data in the data memory 4. Access to these data occurs as needed in the course of the data interpretation. For example, it is conceivable that a speaker box 8, 8′ asks for a specific setting of a component (e.g., a specific digital filter). In this case, it is first determined by calling up the corresponding interpretation data whether this filter is present in the DSP 2.2, 2.2′ or is perhaps present as a separate component in another location in the signal path of the audio signal processing circuit 2, 2′ or is present at all. If so, the desired filter adjustment values (which are contained in the file transferred by the speaker in “mathematical” form) are converted into corresponding DSP- or component-specific adjustment data. On the other hand, if the requested signal processing is not possible in the amplifier 1, the corresponding data originating from the speaker box can either be ignored or, possibly, an alternative setting of a functional element with a similar function can be found. The user may possibly be informed by means of a warning signal that error-free or maximally optimized signal processing is not possible in the amplifier 1.

The interpretation data stored in the data memory 4 exclusively concern information about hardware and/or software in the amplifier, i.e., about the DSP 2.2, 2.2′ possibly the other functional elements included in the audio signal processing circuit 2, 2′. Since this information is independent of different speaker types, it remains valid for future speaker generations as well. Thus, a calculation of the parameter values based on the data transmitted by the respective speaker boxes 8, 8′ can always be performed under consideration of the interpretation data.

In step S5, the parameter values calculated are forwarded via the data transmission means 5 of the audio signal processing circuit 2, 2′. This is configured in step S6 according to the parameter values received. In the event of the presence of multiple channels, the calculation of the parameter values for each of the channels is performed and a corresponding adjustment of the multichannel DSP 2, 2′ is carried out. In this case, the result is that all connected speaker boxes 8, 8′ present optimized acoustic behavior.

It is not ruled out within the framework of the invention that, in a known manner (see DE 197 26 76 C1), identification data for the speaker boxes 8, 8′ are transmitted to the amplifier 1 and speaker-dependent settings or parameter sets are stored in the amplifier 1 at another location. This process, which functions when the amplifier “recognizes” the speaker, may—under these conditions—even be performed instead of the process according to the invention. It is, however, essential that the public address system remain configurable on the basis of the process according to the invention if the conditions mentioned are no longer met.

FIG. 4 depicts a preferred data format for the data stored in the speaker storage medium 9, 9′. The data format includes a large number of data records that are structured by the use of different data types. For example, the data types CHARACTER (characters, letters), abbreviated as “Char”, INTEGER (whole numbers), abbreviated as “Byte” in FIG. 4 for simplicity, REAL (floating-point number), abbreviated here as “Float”, are used as the format of the individual data fields.

A first data record contains the name of the speaker and comprises 16 data fields of the type Char.

A second data record provides the possibility of applying different variants of data records. This data record defines the signal processing in its structural design. The data record includes the data fields (the associated data types are indicated in parentheses): number of variants M (Byte)/ . . . and a number of M data field sequences variant 1, . . . variant M, each of which enables a more detailed description of the individual variants. The structure of each of these data field sequences is: Character 1 (Char)/ . . . /Character 16 (Char)/Number of elements N (Byte)/Element number 1 (Byte)/ . . . /Element number N (Byte).

Another data record relates to an IIR filter arrangement in the signal path of the audio signal processing circuit 2. This data record contains the data fields (data types): Element ID (Byte)/Element number (Byte)/Number of filters N (Byte)/Overall scaling (Float)/ . . . as well as a number of N data field sequences IIR-Filter 1 through IIR-Filter N, each of which contains five data fields of the data types Byte, Float, Float, Float, Float, and whose structure is explained in more detail in the following. Here, N represents the number of filters included in the filter arrangement.

Another data record relates to the peak limiter, by means of which an overload of the final stage or an overload of the speaker with regard to short-term peak outputs is avoided. The data record includes the data fields (data types): Element ID (Byte)/Element number (Byte)/Maximum peak voltage (Float)/Compression ratio (Float)/Attack time (Float)/Hold time (Float)/Release time (Float)/Averaging time constant (Float).

The English terms “attack”, “hold”, “release” customary in audio technology are used. [Translator note: The German terms are listed in the source document along with the English terms.]

Another data record relates to a cone excursion limiter and includes the data fields (data types): Element ID (Byte)/Element number (Byte)/Number of filters N (Byte)/Overall scaling (Float)/ . . . followed by the already mentioned N data field sequences IIR-Filter 1 through IIR-Filter N, . . . followed by: Maximum peak voltage (Float)/Compression ratio (Float)/Attack time (Float)/Hold time (Float)/Release time (Float)/Averaging time constant (Float).

Another data record includes data with regard to a continuous output limiter and includes the data fields (data types): Element ID (Byte)/Element number (Byte)/Number of filters N (Byte)/Overall scaling (Float)/ . . . followed by the N data field sequences IIR-Filter 1 through IIR-Filter N, . . . followed by: Maximum continuous output (Float)/Compression ratio (Float)/Attack time (Float)/Hold time (Float)/Release time (Float).

Another data record includes the data fields (data types): Element ID (Byte)/Element number (Byte)/Relative time delay (Float) and relates to a time delay of the signal occurring in the amplifier 1 relative to a reference point, for example, the delay in an adjacent channel.

Another data record concerns the amplification and the phasing of the audio signal on the output of the amplifier 1 and includes the data fields (data types): Element ID (Byte)/Element number (Byte)/overall amplification including phase, with the latter indicated by the sign (Float).

The file format explained above (see FIG. 4) enables a substantially complete description of the signal processing algorithms currently used in and amplifier 1 or its DSP 2.2, 2.2′

An important characteristic of the data format is its expandability to signal processing algorithms appearing in the future. Consequently, the data records for description of the individual signal processing or functional elements in the amplifier 1 include the identification field referenced by Element ID. Table 1 lists, by way of example, an association between the values for the data field Element ID and the functional elements currently commonly used (signal processing elements or signal processing functions) in the amplifier 1. Obviously, the table can be expanded by addition of other functional elements.

It is noted that a functional element can generally be implemented both in the form of hardware or software and as a DSP-internal or a DSP-external component in the audio signal processing circuit 2, 2′.

TABLE 1
(Element ID <−> Functional element)

| Element | |
|---|---|
| ID | Description (Signal Processing Element or Function) |
| 0 | -- Reserved -- |
| 1 | IIR-Biquad filter sequence with var. number of filters. For |
| | possible filters, see filter type -- Table 2. |
| 2 | Peak limiter: For prevention of speaker overload due to |
| | excessively high signal peaks or excessively high peak output |
| 3 | Cone excursion limiter: To limit cone excursion of the speaker |
| 4 | Continuous output limiter/Effective value limiter: For prevention |
| | of speaker damage (usually thermal overload) by excessively |
| | high continuous output |
| 5 | Relative time delay of the output signal, for example, for |
| | running time adaptation of the various speaker components |
| | in active speaker systems |
| 6 | Amplification and phase of the overall amplifier and signal |
| | processing unit |

Also for reasons of expandability, the various filters of the filter arrangement for equalization of the speaker transmission function are also provided with an identification field, which is referenced by the term “filter type”. The following Table 2 indicates a possible association of the field variable filter type with a description of the corresponding filter types by characteristic data. The parameters cutoff frequency (fg), quality (Q), amplification (v), mid-frequency (fm), and with the subtractive filter, cutoff frequency all-pass filter (fgAp) as well as cutoff frequency low-pass filter (fgTp) appear as characteristic data. These characteristic data are provided according to FIG. 4 in the data field sequence for the description of a filter type.

TABLE 2
(Filter-ID <−> Filter Type)

| Filter Type | Description | |
|---|---|---|
| 0 | -- Reserved -- | |
| 1 | Low-pass 1st Ord. | Parameter: Cutoff frequency (fg) |
| 2 | Low-pass 2nd Ord. (TP2) | Parameter: Cutoff frequency (fg), quality (Q) |
| 3 | High-pass 1st Ord. | Parameter: Cutoff frequency (fg) |
| 4 | High-pass 2nd Ord. (AP1) | Parameter: Cutoff frequency (fg), quality (Q) |
| 5 | All-pass 1st Ord. | Parameter: Cutoff frequency (fg) |
| 6 | All-pass 2nd Ord. | Parameter: Cutoff frequency (fg), quality (Q) |
| 7 | Bandpass 2nd Ord. | Parameter: Cutoff frequency (fg), quality (Q) |
| 8 | Presence/Absence Filter | Parameter: Cutoff frequency (fg), quality (Q), |
| | or EQ filter 2nd Ord. | amplification (v) |
| 9 | Low shelving filter 1st Ord. | Parameter: Cutoff frequency (fg), amplification (v) |
| 10 | Low shelving filter 2nd Ord. | Parameter: Cutoff frequency (fg), quality (Q), |
| | | amplification (v) |
| 11 | High shelving filter 1st Ord. | Parameter: Cutoff frequency (fg), amplification (v) |
| 12 | High shelving filter 2nd Ord. | Parameter: Cutoff frequency (fg), quality (Q), |
| | | amplification (v) |
| 13 | Subtractive filter | Parameter: Cutoff frequency (fgAp, fgTp), |
| | (All-pass 1st Ord. ± Low-pass 2nd Ord.) | quality (Q), amplification (v) |
| 14 | Notch filter 2nd Ord. | Parameter: Mid-frequency (fm), quality (Q) |

The identification fields for the signal processing elements and for the filter types must be established by convention before the technical realization of the public address system according to the invention (for example, according to Table 1 and 2) and, for compatibility reasons, should then not be changed again. The interpretation of the data received from the speaker boxes 8, 8′ is significantly simplified through the use of the identification fields.

It is clear that the speaker boxes 8, 8′ and the amplifier 1 must absolutely “understand” the same signal processing element or the same filter. Only in this manner is the correct transmission behavior for the speaker boxes set in the audio signal processing circuit 2, 2′.

Alternatively to the use of identification fields for filter types, the description of the filter type could also take place in the data record; however, this results in longer loading times and greater memory requirements.

FIG. 5 depicts by way of example a file for the description of desired signal processing functions for a specific speaker boxes. The structure of this file follows the data format illustrated in FIG. 4.

The name of the speaker (“LS2-12” [LS=loudspeaker]) is reported in the first data record. Data fields which are not needed are occupied by the value 0 (“Null”).

It is discernible from the next data record that four different adjustment variants for the amplifier are reported in the file. The number of variants M=4 is reported according to the depiction in FIG. 4 in the first data field of this data record. Four data field sequences that described the individual variants in detail follow. The name of the first variant is “standard”, the following variants are labeled by the names “high pass”, “HfShelve”, and “Lo-Fi”. It can be discerned from the last four data fields of each data field sequence

that each of the four variants includes three data records, and

that the first variant is defined by the element numbers 1, 5, 6; the second variant, by the element numbers 2, 5, 6; the third variant, by the element numbers 3, 5, 6, and the fourth variant by the element numbers 4, 5, 6.

The element numbers are entered in the second data field in each of the subsequent data records and represent, as already mentioned, serial numbering of those data records that relate to a signal processing element or a signal processing function in the audio signal path. These are precisely those data records whose first data field is a data identification field (“Element ID”), i.e., in the example depicted in FIG. 4, all data records, with the exception of the data record for the speaker name and the data record for the variant definition.

According to the variant definition, the four variants differ from each other in that they alternatively include the data records with the element numbers 1 or 2 or 3 or 4, in contrast with which the data records with the element numbers 5 and 6 are included in all variants. The data records with the element numbers 1 through 4 describe four different filter sequence versions. The first two filter sequence versions (data records with the element numbers 1 and 2) contain only one filter. In both cases, this is the same filter (filter type 4), whereby the only difference is in the frequency setting values for the frequency response (50 and 150, respectively).

The data records with the element numbers 3 and 4 have in each case three filters of identical filter types (i.e., 4, 8, 8). The differences between the signal processing functions expressed by these two data records are again found in the different setting values for the filter of the filter type 4.

The next data record with the element ID=2 relates to the peak limiter and contains the setting values for the data fields of this data record defined according to FIG. 4.

The data records for the cone excursion limiter, the continuous output/effective value limiter and the relative time delay (element ID=3, 4, 5) are not supplied. The data record with the element ID=6 appearing in the last position in the exemplary file has an overall amplification factor 30 with negative phase (negative sign).

The identification fields, variable and field types indicated as well as the structure of the individual data records and the elements can be defined and structured in many other ways. It is critical that, on the one hand, the most comprehensive description possible of all possible signal processing functions is supported in an amplifier by the data format selected, and that, on the other, short transmission times and a simple, low-calculation-overhead interpretation of the data delivered by the speaker boxes in this format is possible. In addition, the file format should be designed “open”, as in the example depicted here, such that future developments in the amplifier sector can be taken into account by “backward compatible” format enhancement.

The interpretation data contained in the data memory 4 of the amplifier 1 include specific technical data or numerical values concerning the structure or the specifications of the amplifier hardware including firmware that are necessary to calculate an “operable” parameter set from the data received from the speaker boxes. In contrast to the data delivered by the speaker box, they do not have to be structured according to a special, universal format conventions [sic].

The interpretation data may include the following data, among others:

data that indicate the number of channels in the amplifier;

data that indicate the sampling frequency used in the DSP 2.2, 2.2′ (this can possibly differ from the sampling frequency of the analog-digital converter 2.1, 2.1′);

data that indicate the basic amplification of the amplifier 1;

data that indicate the short-term maximum output voltage (e.g., as a sine RMS value) of the amplifier 1; and

data that indicate the time delays of the analog-digital converter 2.1, 2.1′, the digital-analog converter 2.3, 2.3′, and the DSP 2.2, 2.2′.

List of Reference Characters

1 Amplifier

2, 2′ Audio signal processing circuit

2.1, 2.1′ Analog-digital converter

2.2, 2.2′ DSP [digital signal processor]

2.3, 2.3′ Digital-analog converter

2.4, 2.4′ Power amplifier

3 Configuration circuit

4 Data memory

5 Data transmission means

6 Data transmission means

7 Input signal

8, 8′ Speaker box

9, 9′ Storage medium

10 Cable connection

11, 11′ Speaker cable

12, 12′ Data transmission line

S1—S6 Process steps

1. Process for the configuration of a public address system with at least one speaker box (8, 8′) and one amplifier (1) including a digital signal processing section, in particular a DSP (2.2, 2.2′), in the audio signal path, supplying the speaker box (8, 8′) with an audio signal, whereby data are stored in the speaker box (8, 8′), which data are transmitted to the amplifier (1) and with reference to which signal processing in the digital signal processing section of the amplifier (1) adapted to sound technology and/or electrical characteristics or surrounding conditions of the speaker box (8, 28′) is adapted, whereby
the data relate to a desired signal processing in the digital signal processing section and are structured in a data format specific neither to the digital signal processing section nor to the speaker box (8, 8′),
the data or a portion thereof are converted, in an interpretation step (S4) occurring in the amplifier (1), into parameter data specific to the digital signal processing section suitable for the configuration thereof, and
interpretation data held in the amplifier (1) are used for data interpretation, which interpretation data contain information concerning the nature of the digital signal processing section used.

2. Process according to claim 1,
characterized in
that the data stored in the speaker box (8, 8′) are subdivided into multiple data records each with a predefined relationship with regard to content.

3. Process according to one of the preceding claims,
characterized in
that at least some of the data records are in each case associated with a functional element known in amplifier technology, whereby the respective functional element is uniquely identifiable by means of a functional element identification data field in the corresponding data record.

4. Process according to claim 3,
characterized in
that a first data record is associated with a filter sequence.

5. Process according to claim 4,
characterized in
that the first data record has a filter identification data field that serves for the identification of different filter types.

6. Process according to claim 3 through 5,
characterized in
that a second data record is associated with a peak limiter to prevent overloading of the speaker box (8, 8′) with excessively high signal peaks.

7. Process according to claim 3 through 6,
characterized in
that a third data record is associated with a cone excursion limiter to limit cone excursion.

8. Process according to claim 3 through 7,
characterized in
that a fourth data record is associated with a continuous output limiter to limit the continuous output power.

9. Process according to claim 3 through 8,
characterized in
that a fifth data record is associated with a relative time delay of the audio signal with regard to other outputs of the amplifier (1).

10. Process according to claim 3 through 9,
characterized in
that a sixth data record is associated with the amplification and the phase of the audio signal output by the amplifier.

11. Process according to claim 3 through 10,
characterized in
that a data record has a data record identification data field by means of which multiple versions of the data record are distinguishable.

12. Process according to one of the preceding claims, characterized in
that preset parameter data for functional elements of the digital signal processing section, in particular a DSP (2.2, 2.2′), are stored in the amplifier (1), and
that the preset parameter data are used to adjust the associated functional elements, when no data are transmitted for this from the speaker box (8, 8′).

13. Process according to one of the preceding claims,
characterized in
that before the conversion of the data received into parameter data for the digital signal processing section, in particular a DSP (2.2, 2.2′), a check is performed as to whether the digital signal processing section actually makes the required signal processing available.

14. Process according to claim 13,
characterized in
that a warning is output if the check yields the result that a required signal processing cannot be executed by the digital signal processing section, in particular a DSP (2.2, 2.2′).

15. Process according to one of the preceding claims,
characterized in
that a warning is output if the occurrence of an error is detected during the interpretation of the data.

16. Public address system with at least one speaker box (8, 8′) and one amplifier (1) including a digital signal processing section, in particular a DSP (2.2, 2.2′), in the audio signal path, supplying the speaker box (8, 8′) with an audio signal, whereby
the speaker box (8, 8′) includes a data memory (9, 9′) in which data are stored, which relate to desired signal processing in the amplifier (1) and which are structured in a data format specific neither to the digital signal processing section nor to the speaker box (8, 8′), and
the amplifier (1) has a data memory (4) to store interpretation data, which have as content information concerning the nature of the digital signal processing section used in the speaker box (1), and
includes an interpretation unit which calculates parameter data by means of the interpretation data received from the speaker box (8, 8′), which are suitable for the configuration of the digital signal processing section.

17. Speaker box,
characterized by
a data memory (9, 9′), in which data are stored in a predefined data format independent of the type of speaker box (8, 8′), which relate to specific, desired signal processing in any digital processing sections of amplifiers (1).

18. Configurable amplifier that has a digital processing section in the audio signal path and can be connected for output of an audio signal to a speaker box that further has a configuration circuit (3),
to which data can be forwarded by the speaker box (8, 8′) that relate to desired signal processing in the amplifier,
which has a data memory (4) for storage of interpretation data that relate to information concerning the digital signal processing section used in the amplifier (1), and
which includes an interpretation unit which calculates parameter data by means of the interpretation data received from the speaker box (8, 8′) with the precondition of a predefined data format of these data independent of the type of speaker, which data are suitable for the configuration thereof specific to the digital signal processing section.
